(19) United States
(12) Patent Application Publication
(10) Pub. No.: US 2019/0161368 A1
(43) Pub. Date: May 30, 2019

(54) SPILLED OIL COLLECTING APPARATUS AND METHOD

(71) Applicant: KOREA INSTITUTE OF SCIENCE AND TECHNOLOGY, Seoul (KR)

(72) Inventors: Myoung Woon MOON, Seoul (KR); Young A LEE, Seoul (KR); Tae Jun KO, Seoul (KR); Min Sung KIM, Seoul (KR); O Chang KWON, Seoul (KR); Kyu Hwan OH, Seoul (KR)

(21) Appl. No.: 16/184,940

(22) Filed: Nov. 8, 2018

(30) Foreign Application Priority Data
Nov. 24, 2017 (KR) 10-2017-0158566

(51) Int. Cl. C02F 1/40; B01D 17/04; E02B 15/04

(52) U.S. Cl. CPC C02F 1/40; B01D 17/045; C02F 2101/32; E02B 15/048; E02B 15/045

(57) ABSTRACT

Provided are spilled oil collecting apparatus and method. The spilled oil collecting apparatus includes: a filter portion made of a porous substrate with hydrophilicity and having an open upper portion so as to collect oil; a frame portion provided at an upper end of the filter portion to support the filter portion; and a handle portion connected to the frame portion. According to the spilled oil collecting apparatus and method, it is possible to collect, separate, and store simultaneously spilled oil spilled from rivers or seas by using a porous substrate having hydrophilicity and optimize immediate collection of spilled oil by maximizing oil collection efficiency and minimizing labour force in an oil collecting process.

### CROSS-REFERENCE TO RELATED APPLICATION

This application claims the benefit of Korean Patent Application No. 10-2017-0158566, filed on Nov. 24, 2017, in the Korean Intellectual Property Office, the disclosure of which is incorporated herein in its entirety by reference.

### BACKGROUND

### 1. Field

One or more embodiments relate to spilled oil collecting apparatus and method and more particularly, to a spilled oil collecting apparatus and a spilled oil collecting method using the same capable of collecting spilled oil on water in an area such as a beach or river where oil spill contamination occurs.

### 2. Description of the Related Art

When an oil spill occurs in the sea or river, oil or hazardous & noxious substances (HNS) float on the surface of the seawater or river and spreads rapidly around the seawater or river to cause serious environmental pollution. Therefore, when an oil or HNS spill occurs, it is important to quickly remove the spilled oil or HNS.

When oil spills, generally, a method of sinking the oil to the bottom of the sea or river by spraying an emulsifier on the water surface where the oil floats, a method of removing the oil from the shoreline by using a suction pad after the pollutant has propagated to the shore, or the like is used. However, the emulsifier has a problem of causing secondary contamination by submerging the oil on the bottom, and the oil removal by the suction pad is a method that may be used only after the propagation of the pollutant has already proceeded seriously. Therefore, a technique for effectively blocking the spread of the oil and collecting the oil is required.

### SUMMARY

One or more embodiments provide a spilled oil collecting apparatus capable of collecting and simply storing spilled oil while passing water.

One or more embodiments provide a spilled oil collecting method capable of collecting spilled oil by using the spilled oil collecting apparatus.

Additional aspects will be set forth in part in the description which follows and, in part, will be apparent from the description, or may be learned by practice of the presented embodiments.

According to one or more embodiments, a spilled oil collecting apparatus includes: a filter portion made of a porous substrate with hydrophilicity and having an open upper portion so as to collect oil; a frame portion provided at an upper end of the filter portion to support the filter portion; and a handle portion connected to the frame portion.

The porous substrate may have a non-woven fabric, fabric, mesh, or net shape.

The porous substrate may include at least one of plastic, fiber, glass, metal, ceramic and carbon-based materials.

The plastic may include at least one of polypropylene, polyethylene, polyethylene terephthalate, polystyrene, polymethyl methacrylate, polyvinylidene fluoride, polytetrafluoroethylene, and copolymers thereof.

The fiber may include natural fibers, artificial fibers or combinations thereof, the natural fiber may include at least one of cotton, hemp, wool, silk, and asbestos, and the artificial fiber may include at least one of rayon, modal, tencel, lyocell and polynosic, acetate, triacetate, polyamides, polyolefins, polyesters, acrylics, poly(meth)acrylates, polyvinyl alcohol (PVA), polyurethane, polyvinyl chloride (PVC), polyvinylidene chloride (PVDC), polystyrene, cellulose, glass fibers, and copolymers thereof.

The metal may include at least one of iron (Fe), aluminum (Al), stainless steel, copper (Cu), platinum (Pt), gold (Au), silver (Ag), titanium (Ti), silicon (Si), and alloys thereof.

The carbon-based material may include at least one of graphite, carbon fiber, diamond, and graphene.

The porous substrate may include polymeric or metallic fibers having an average diameter of about 10 nanometers to about 500 micrometers.

The porous substrate may have a contact angle to water in air of 20° or less.

The porous substrate may have a contact angle to oil in water of 140° or less.

The spilled oil collecting apparatus may further include: a mesh-shaped support which is connected to the frame portion and is disposed on the inside, the outside, or both the inside and the outside of the filter portion to support the filter portion.

The support may include a metal or plastic material.

The frame portion may have a circular or polygonal shape.

The handle portion may have a foldable structure which is adjustable in length.

The handle portion may include a multi-stage bag portion provided in the form of a foldable bar, and the bag portion includes n bars (here, 2≤n≤10) whose diameters are sequentially increased, and an n-th bar is slid into a (n−1)-th bar so as to be foldable.

The spilled oil collecting apparatus may further include: a fastening member for connecting and fixing the filter portion and the frame portion.

The filter portion may have a trap net shape such as an ellipse, a cylinder, a trapezoid, a cone, or a gourd bottle.

The filter portion may have a depth of about 1 cm to about 10 m.

The handle portion may have a length of about 1 m to about 10 m.

According to one or more embodiments, a spilled oil collecting method includes: collecting oil by selectively transmitting water of the water and oil using the spilled oil collecting apparatus.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an example of a spilled oil collecting apparatus according to an embodiment;

FIG. 2 is a schematic diagram schematically illustrating a spilled oil collecting process using the spilled oil collecting apparatus according to an embodiment;

FIG. 3 is an image for an application example using the spilled oil collecting apparatus according to an embodiment;

FIG. 4 is a sequential view of a process of collecting and storing oil floating on a water surface using the spilled oil collecting apparatus according to an embodiment;

FIG. 5 is a schematic diagram illustrating various types of a filter portion of the spilled oil collecting apparatus according to one embodiment;

FIGS. 6A to 6C are schematic diagrams of three types of the spilled oil collecting apparatus according to one embodiment;

FIG. 7 illustrates a camera image and a scanning electron microscope (SEM) image of a porous substrate used in a spilled oil collecting apparatus according to Example 1;

FIG. 8 is an image illustrating that the porous substrate used for the spilled oil collecting apparatus according to Example 1 is hydrophilic, in which water is spread well in air;

FIG. 9 is an image illustrating a contact angle to oil in water in the porous substrate used in the spilled oil collecting apparatus according to Example 1; and

FIG. 10A is an image of an oil intrusion pressure evaluation result on the porous substrate used in the spilled oil collecting apparatus according to Example 1 and FIG. 10B is an oil intrusion pressure according to pores of the material.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Meanwhile, the terminology used in the following description is used only to describe specific embodiments and is not intended to limit the present disclosure. An expression in the singular includes an expression in the plural unless the content clearly indicates otherwise. In the following description, it should be understood that terms, such as “include” and “have”, are used to indicate the presence of stated features, numbers, steps, operations, elements, parts, components, materials, or a combination thereof described in the specification without excluding in advance the possibility of the presence or addition of one or more other features, numbers, steps, operations, elements, parts, components, materials, or combinations thereof.

Hereinafter, spilled oil collecting apparatus and method according to an embodiment and will be described in detail with reference to the accompanying drawings.

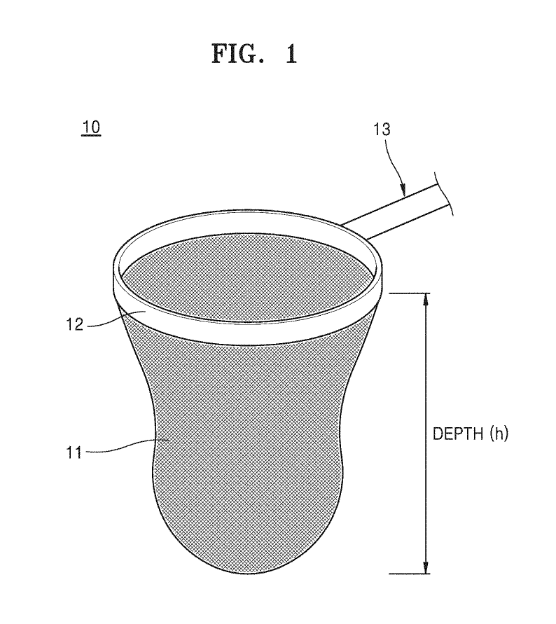

FIG. 1 illustrates an example of a spilled oil collecting apparatus according to an embodiment.

As shown in FIG. 1, a spilled oil collecting apparatus 10 according to an embodiment includes: a filter portion 11 made of a porous substrate with hydrophilicity and having an open upper portion so as to collect oil; a frame unit 12 provided at an upper end of the filter portion 11 to support the filter portion 11; and a handle portion 13 connected to the frame unit 12.

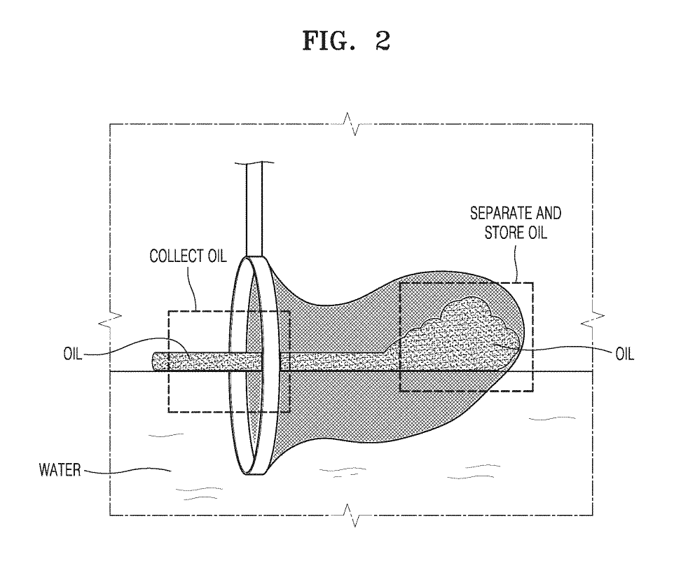

The filter portion 11 is made of a porous substrate with hydrophilicity and has an open upper portion so as to collect oil. The filter portion 11 is a space for separating and storing the oil spilled on the water. FIG. 2 is a schematic diagram schematically illustrating a spilled oil collecting process using the spilled oil collecting apparatus 10 according to an embodiment. FIG. 2A is a situation of collecting oil floating on the water surface and FIG. 2B is a situation illustrating a function of preventing contamination by directly receiving and storing oil before the oil is spilled from a contamination source. As shown in FIG. 2, when the spilled oil collecting operation is performed on the water floating with the oil by using the spilled oil collecting apparatus, the oil is collected at the inlet of the filter portion 11, and the collected oil may be stored in the filter portion 11 by buoyancy. The water and oil are introduced to the inlet of the filter portion 11, but due to a hydrophilic property of a porous material constituting the filter portion 11, the water is removed out of the filter portion 11 and the oil is trapped in the filter portion 11 due to an underwater oleophobic property in the water.

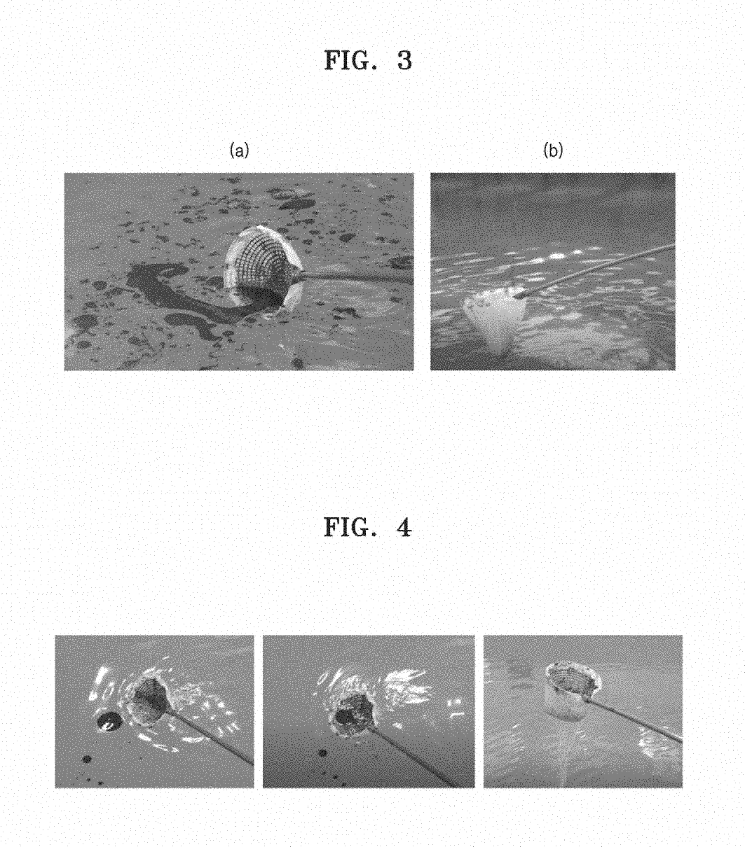

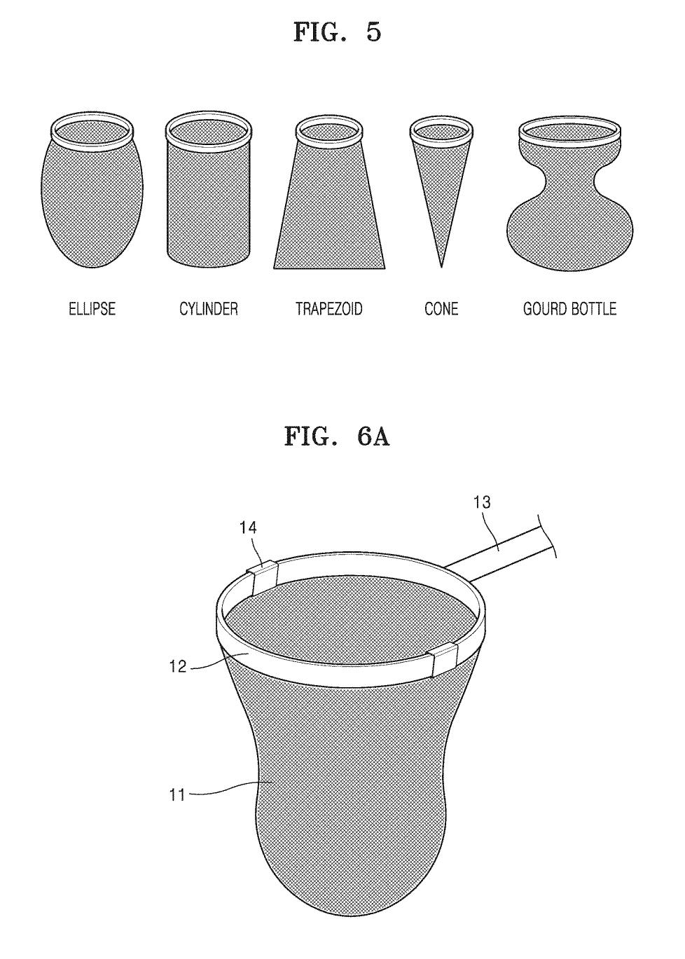

FIG. 3 shows an application example using the spilled oil collecting apparatus according to an embodiment, and FIG. 4 shows a continuous situation of a process of collecting and storing oil floating on a water surface. As shown in FIGS. 3 and 4, if the oil spilled on the water is collected and finally the spilled oil collecting apparatus is lifted from the water surface, the water is removed by passing through the filter portion 11 and only the remaining oil which does not pass therethrough may be recovered in the filter portion 11.

The hydrophilic porous substrate constituting the filter portion 11 may be in the form of non-woven fabric, fabric, mesh or net. The porous substrate may have a microporous structure ranging from hundreds of nanometers to tens of micrometers.

The porous substrate may have a contact angle to water in air of 20° or less. A contact angle to purified water in air of 20° or less is defined as “hydrophilic”, and a contact angle of less than 10° is defined as “superhydrophilic”, and the porous substrate may have hydrophilicity and superhydrophilicity with a contact angle to water in air of 20° or less. The water is transmitted, but the oil is not transmitted through the hydrophilic porous substrate.

On the other hand, the porous substrate may exhibit underwater oleophobicity or underwater superoleophobicity in which oil is not absorbed in the porous substrate but remains in the form of spherical droplets in water. Accordingly, the porous substrate may have a high contact angle to oil in water, for example, 140° or greater. This provides an important reason why oil may be stored in water. Particularly, since an oil contact angle to bunker C oil with high viscosity (viscosity of about 5000 cSt to about 1000 cSt) which causes the most frequent oil spill accident at sea is 160° or greater, it is possible to collect various oil types from low-viscosity crude oil (about 1 cSt to about 10 cSt) to high-viscosity oil.

The porous substrate may be made of at least one of plastics, fibers, glass, metal, ceramics, and carbon-based materials.

The plastics are not particularly limited and may include, for example, at least one of polypropylene, polyethylene, polyethylene terephthalate, polystyrene, polymethyl methacrylate, polyvinylidene fluoride, polytetrafluoroethylene, and copolymers thereof.

The fibers may include natural fibers, artificial fibers or combinations thereof. Examples of the natural fibers may include cotton, hemp, wool, silk, asbestos fibers, and combinations thereof. The artificial fibers may include, for example, i) regenerated fibers such as rayon, modal, tencel, lyocell and polynosic; ii) semi-synthetic fibers such as acetate and triacetate; iii) synthetic fibers such as polyamides such as nylon, Nomex and Kevlar, polyolefins such as polyethylene and polypropylene, polyesters such as polyethylene terephthalate, acrylics, poly(meth)acrylates, polyvinyl alcohol (PVA), polyurethane, polyvinyl chloride (PVC), polyvinylidene chloride (PVDC), polystyrene, and cellulose; inorganic fibers such as glass fibers; or copolymers thereof, but are not limited thereto.

The metal may include at least one of iron (Fe), aluminum (Al), stainless steel, copper (Cu), platinum (Pt), gold (Au), silver (Ag), titanium (Ti), silicon (Si), and alloys thereof.

The carbon-based material may include at least one of graphite, carbon fiber, diamond, and graphene.

According to one embodiment, the porous substrate may include polymeric or metallic fibers having an average diameter of about 10 nanometers to about 500 micrometers. A hydrophilic porous filter portion 11 having desired characteristics may be manufactured using the fiber material.

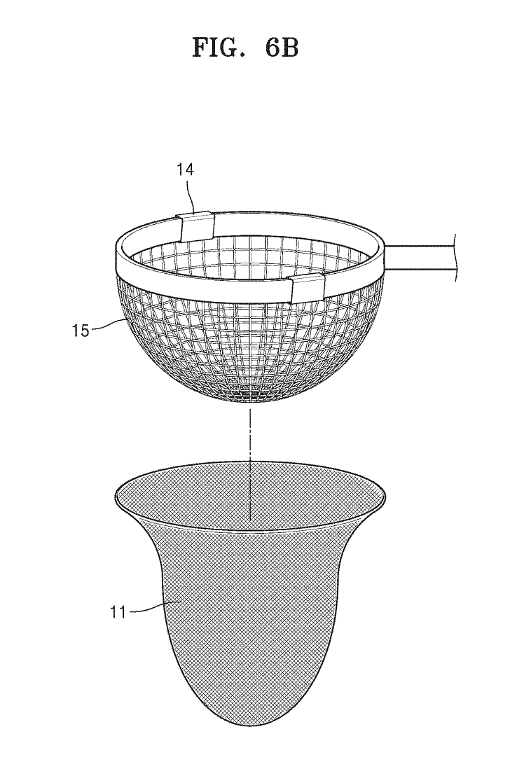

The filter portion 11 may be manufactured in the form of a mesh having a shape similar to a trap net by using the porous substrate. A depth h of the filter portion 11 is sufficiently long and the shape of the side surface may be variously shaped so that the collected oil may be stored therein. For example, as shown in FIG. 5, the filter portion 11 may have various shapes such as an ellipse, a cylinder, a trapezoid, a cone, or a gourd bottle. The depth h of the filter portion 11 may be in a range of, for example, about 1 cm to about 10 m, about 10 cm to about 5 m, about 30 cm to about 3 m, about 40 cm to about 2 m, and about 50 cm to about 1 m. In the range, the oil is collected in the filter portion 11 and the collected oil may be sufficiently stored.

At the upper end of the filter portion 11, the frame portion 12 for supporting the filter portion 11 is provided.

According to one embodiment, the filter portion 11 may be provided with an opening/closing means using a zipper or a string at the upper portion thereof, thereby providing easier convenience when the filter portion 11 is inserted into the frame portion 12.

The frame portion 12 may be of various types according to the use conditions and the use environments of the spilled oil collecting apparatus. By various methods such as a form of covering a circumference of the frame portion 12 with a porous material of the upper end of the filter portion 11 and a form of inserting and fixing the upper end of the filter portion 11 between double-layered frame portions 12, the filter portion 11 may be bonded to the frame portion 12. The frame portion 12 may have various polygonal shapes such as a circle, an ellipse, a triangle, a square, or the like and may be formed of a material having high strength properties such as a metal or a polymeric material having durability.

According to one embodiment, the frame portion 12 may include two or more elastic members and an elastic member coupling means for coupling the front ends of the elastic members. The elastic member may form the opening portion of the filter portion 11 into a circular shape or a polygonal shape by connecting the front ends of the two or more elastic members by the elastic member coupling means.

The frame portion 12 may have a structure that may be folded in a straight shape or folded in a circular shape or a polygonal shape to facilitate storage.

The spilled oil collecting apparatus may further include a fastening member 14 so as to more firmly fix the filter portion 11 and the frame portion 12 by connecting the filter portion 11 and the frame portion 12 to each other. The fastening member 14 may have a clip shape, and two or more fastening members 14 may be provided at the upper end of the filter portion 11 and the frame portion 12 to fasten the filter portion 11 and the frame portion 12 to each other.

According to an embodiment, the spilled oil collecting apparatus 10 may further include a mesh-shaped support 15 which is connected to the frame portion 12 and is disposed on the inside, the outside, or both the inside and the outside of the filter portion 11 to support the filter portion 11. The support 15 may be made of a metal or plastic material.

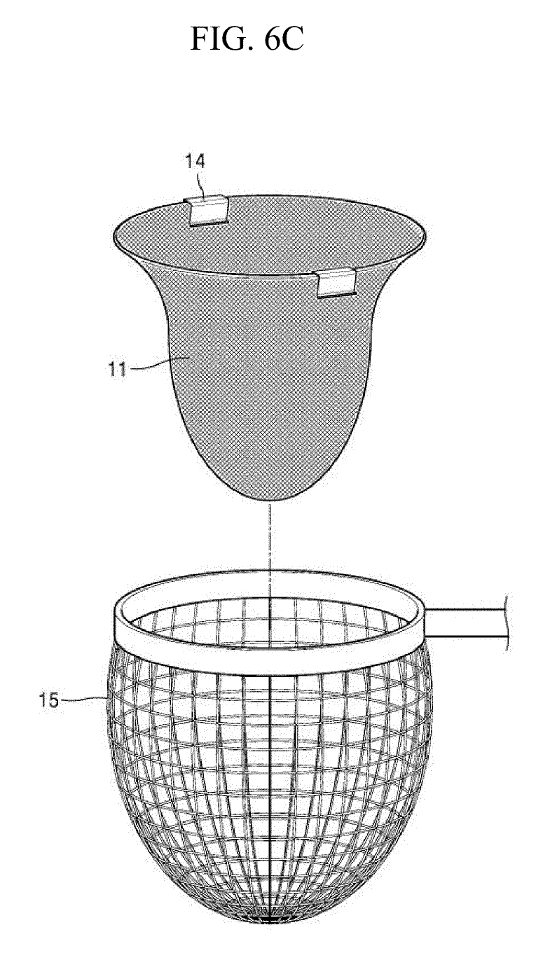

FIGS. 6A to 6C are schematic diagrams of three types of the spilled oil collecting apparatus according to one embodiment.

As shown in FIG. 6A, the spilled oil collecting apparatus may have a structure in which the frame portion 12 has a ring shape and the mesh-shaped filter portion 11 is directly connected to the ring-shaped frame portion 12 to form the filter portion 11. Such a structure is spread over a large area, but may be advantageous when a small amount of spilled oil is recovered. The fastening member 14 may be further included so as to more firmly fix the filter portion 11 and the frame portion 12 by connecting the filter portion 11 and the frame portion 12 to each other. The filter portion 11 may be provided with an opening/closing means for facilitating the storage and carriage of the spilled oil collecting apparatus so that the filter portion 11 may be easily inserted into the frame portion 12.

As shown in FIG. 6B, the spilled oil collecting apparatus is provided with a support 15 having a wide mesh shape inside the filter portion 11 and may have a structure in which the hydrophilic filter portion 11 covers the outside of the support 15. The support 15 having the wide mesh shape may filter out solid waste floating on the sea to protect the spilled oil collecting apparatus from the damage by the solid waste and the like.

As shown in FIG. 6C, the spilled oil collecting apparatus is provided with a support 15 having a wide mesh shape outside the filter portion 11 and may have a structure in which the hydrophilic filter portion 11 is disposed inside the support 15. This structure may improve the durability of the filter portion 11 and increase the storage capacity of the collected oil to provide high durability to the spilled oil collecting apparatus.

In the spilled oil collecting apparatus, a handle portion 13 is connected to the frame portion 12. The length of the handle portion 13 may be, for example, 1 m to 10 m and 1 m to 5 m. In the range, the spilled oil collecting apparatus may be used for sea decontamination.

The handle portion 13 may be made of aluminum or a carbon-reinforced material to reduce its weight.

The handle portion 13 may have a foldable structure that may be adjusted in length.

For example, the handle portion 13 includes a multi-stage bag portion provided in the form of a foldable bar, wherein the bag portion includes n bars (here, 2≤≤10) whose diameters are sequentially increased, and an n-th bar may be slid into a (n−1)-th bar so as to be foldable.

The spilled oil collecting apparatus according to an embodiment has a function of continuously collecting the spilled oil in a temporally stored state while collecting and separating the spilled oil floating on the water, thereby maximizing a collecting rate of the oil by only one operation and minimizing labor force to be administered. In addition, since repeated use is possible, unlike an oil removing non-woven fabric in the related art, the spilled oil collecting apparatus may be economic without causing new environmental contamination problems.

A spilled oil collecting method according to an embodiment includes collecting oil by selectively transmitting water of water and oil using the aforementioned spilled oil collecting apparatus.

The spilled oil collecting apparatus has high wettability using a porous substrate having hydrophilicity and easily transmits the water. Accordingly, when a mixed liquid of the oil and the water passes through the spilled oil collecting apparatus, the water easily passes through the filter portion 11 of the spilled oil collecting apparatus, but the oil does not pass through the filter portion 11 due to repulsive force against water and is filtered in the filter portion 11.

According to one embodiment, in performing the spilled oil collecting method, before the spilled oil collecting apparatus is used, the method may further include a pre-treatment step of soaking oil in water. Through the soaking process, a water film is formed on the surface of the filter portion 11 of the spilled oil collecting apparatus, thereby more efficiently filtering the oil.

Hereinafter, one or more embodiments will be described in more detail with reference to Examples.

The morphology structures of surfaces prepared in the following Examples and Comparative Examples were examined by a scanning electron microscope (SEM, FEI, Nova NanoSEM 200, USA). A contact angle (CA) to water was measured with a contact angle meter (Goniometer, Rame-Hart, USA). The volume of each droplet used at a static contact angle was 8 μl. The average CA values were measured at five different locations for the same sample. The oil used was olive oil and crude oil.

### Example

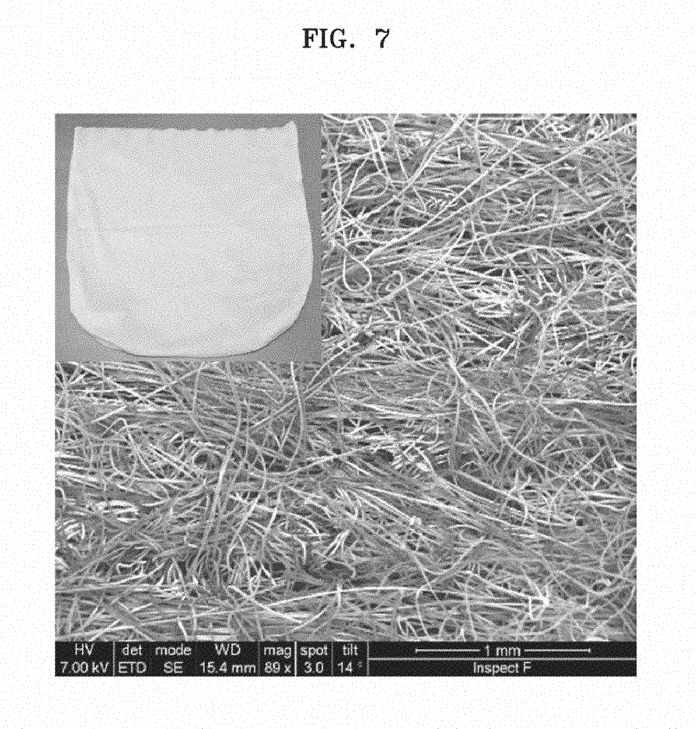

A filter portion was fabricated in the form of a cylindrical net shown in the upper left end of FIG. 7 by using a non-woven fabric made of cellulose fibers having a diameter of about 10 to 20 μm. The depth h of the filter portion was about 40 cm. The filter portion was connected to a circular frame and the circular frame was connected to a handle portion. The frame and the handle portion were made of plastic materials.

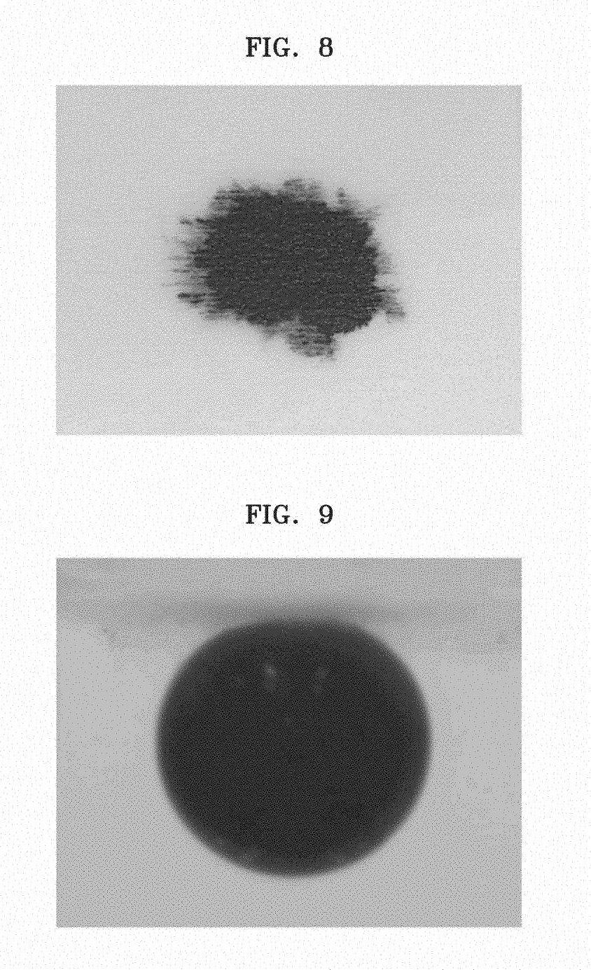

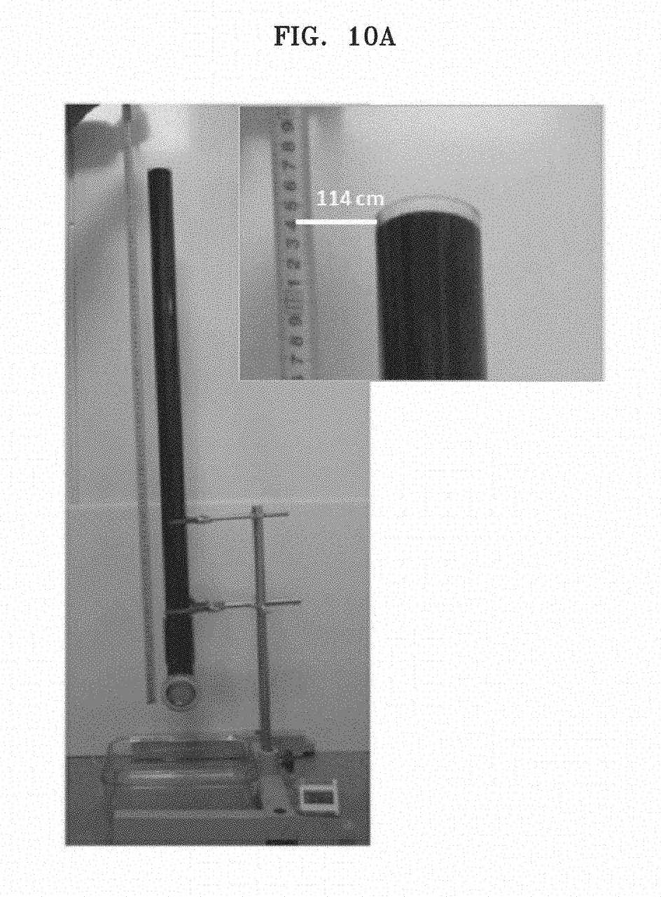

FIG. 7 is a camera image and an SEM image for a filter portion material which may be connected to a cylindrical frame. The filter material was a porous material in the form of a non-woven fabric. As shown in FIG. 8, the filter material has a hydrophilic property in that water was well spread in air, and a contact angle to water is almost 0°, and the filter material may be absorbed well in air or water. On the other hand, as shown in FIG. 9, the filter material had a superoleophobic property of a contact angle to oil in water of about 163° or more, and may have a function capable of storing oil in water.

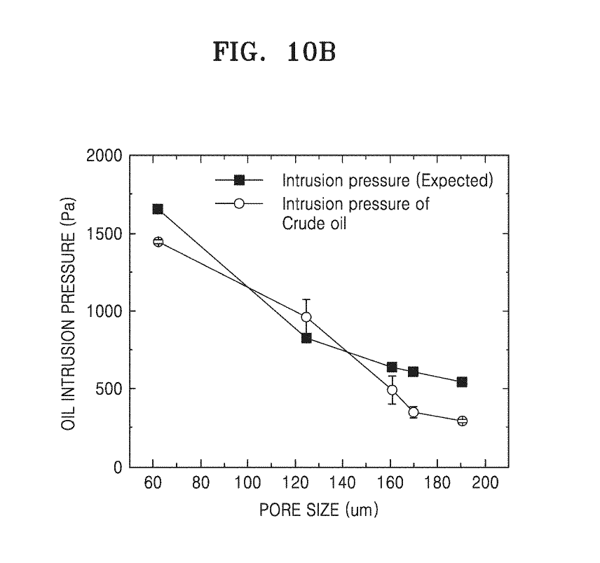

FIG. 10A is an image of an oil intrusion pressure evaluation result on the porous substrate used in the spilled oil collecting apparatus according to Example 1 and FIG. 10B is an oil intrusion pressure according to pores of the material. It can be seen that crude oil (density=916 kg/m³) was held up to a height of 1.14 m by a hydrophilic material (pore size of about 121 μm) for the spilled oil collecting apparatus, and it was calculated with oil intrusion pressure, wherein the calculation was density of oil×gravity acceleration (9.8 m/s²)×height (m) of oil and 916×9.8×1.14=10,233 kg/m·s²=10,233 Pa. The value varies according to the size of the pore, and as shown in FIG. 7B, it can be seen that when the pore size was the smallest, the intrusion pressure is high and the pore size is gradually increased, so that the intrusion pressure is reduced (in the case of a pore size of 190 μm, the oil intrusion pressure is 190 Pa and the intrusion height is up to 0.31 m). On the other hand, if the size of the pore increases, it is advantageous that the speed of removing the water is increased. In the case of the spilled oil collecting apparatus using the porous material of Example 1, the maximum oil storable capacity of a width of 30 cm and a depth of 40 cm was V=pi*R²*h=3.14×15̂²×40=28,260 cm³ to 28.26 liters. When the depth of the filter portion having the same width is 100 cm, the spilled oil may be collected up to about 70.65 liters.

As described above, according to one or more embodiments, in the spilled oil collecting apparatus and method according to one or more embodiments, it is possible to collect, separate, and store simultaneously spilled oil spilled from rivers or seas by using a porous substrate having hydrophilicity and optimize immediate collection of spilled oil by maximizing oil collection efficiency and minimizing labour force to be administered in an oil collecting process.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A spilled oil collecting apparatus comprising:
a filter portion made of a porous substrate with hydrophilicity and having an open upper portion so as to collect oil;
a frame portion provided at an upper end of the filter portion to support the filter portion; and
a handle portion connected to the frame portion.

2. The spilled oil collecting apparatus of claim 1, wherein the porous substrate has a non-woven fabric, fabric, mesh, or net shape.

3. The spilled oil collecting apparatus of claim 1, wherein the porous substrate comprises at least one of plastic, fiber, glass, metal, ceramic and carbon-based materials.

4. The spilled oil collecting apparatus of claim 3, wherein the plastic includes at least one of polypropylene, polyethylene, polyethylene terephthalate, polystyrene, polymethyl methacrylate, polyvinylidene fluoride, polytetrafluoroethylene, and copolymers thereof.

5. The spilled oil collecting apparatus of claim 3, wherein the fiber includes natural fibers, artificial fibers or combinations thereof, the natural fiber includes at least one of cotton, hemp, wool, silk, and asbestos, and the artificial fiber includes at least one of rayon, modal, tencel, lyocell and polynosic, acetate, triacetate, polyamides, polyolefins, polyesters, acrylics, poly(meth)acrylates, polyvinyl alcohol (PVA), polyurethane, polyvinyl chloride (PVC), polyvinylidene chloride (PVDC), polystyrene, cellulose, glass fibers, and copolymers thereof.

6. The spilled oil collecting apparatus of claim 3, wherein the metal includes at least one of iron (Fe), aluminum (Al), stainless steel, copper (Cu), platinum (Pt), gold (Au), silver (Ag), titanium (Ti), silicon (Si), and alloys thereof.

7. The spilled oil collecting apparatus of claim 3, wherein the carbon-based material includes at least one of graphite, carbon fiber, diamond, and graphene.

8. The spilled oil collecting apparatus of claim 1, wherein the porous substrate includes polymeric or metallic fibers having an average diameter of about 10 nanometers to about 500 micrometers.

9. The spilled oil collecting apparatus of claim 1, wherein the porous substrate has a contact angle to water in air of 20° or less.

10. The spilled oil collecting apparatus of claim 1, wherein the porous substrate has a contact angle to oil in water of 140° or less.

11. The spilled oil collecting apparatus of claim 1, further comprising:
a mesh-shaped support which is connected to the frame portion and is disposed on the inside, the outside, or both the inside and the outside of the filter portion to support the filter portion.

12. The spilled oil collecting apparatus of claim 11, wherein the support comprises a metal or plastic material.

13. The spilled oil collecting apparatus of claim 1, wherein the frame portion has a circular or polygonal shape.

14. The spilled oil collecting apparatus of claim 1, wherein the handle portion has a foldable structure which is adjustable in length.

15. The spilled oil collecting apparatus of claim 1, wherein the handle portion includes a multi-stage bag portion provided in the form of a foldable bar, and the bag portion includes n bars (here, 2≤n≤10) whose diameters are sequentially increased, and an n-th bar is slid into a (n−1)-th bar so as to be foldable.

16. The spilled oil collecting apparatus of claim 1, further comprising:
a fastening member for connecting and fixing the filter portion and the frame portion.

17. The spilled oil collecting apparatus of claim 1, wherein the filter portion has a trap net shape such as an ellipse, a cylinder, a trapezoid, a cone, or a gourd bottle.

18. The spilled oil collecting apparatus of claim 1, wherein the filter portion has depth of about 1 cm to about 10 m.

19. The spilled oil collecting apparatus of claim 1, wherein the handle portion has a length of about 1 m to about 10 m.

20. A spilled oil collecting method comprising:
collecting oil by selectively transmitting water of the water and oil using the spilled oil collecting apparatus of claim 1.
